(19) United States
(12) Patent Application Publication
(10) Pub. No.: US 2016/0208667 A1
(43) Pub. Date: Jul. 21, 2016

(54) ENGINE EMISSION ABSORBER ASSEMBLY AND METHOD FOR OPERATING SAME

(71) Applicant: Caterpillar Inc., Peoria, IL (US)

(72) Inventor: Xinyu Ge, Peoria, IL (US)

(73) Assignee: Caterpillar Inc., Peoria, IL (US)

(21) Appl. No.: 14/598,644

(22) Filed: Jan. 16, 2015

(51) Int. Cl. F01N 3/033; F02M 25/08; B01D 53/94; F01N 3/022; B01J 38/00

(52) U.S. Cl. CPC F01N 3/033; F01N 3/0222; B01J 38/00; B01D 53/9495; B01D 53/9481; F02M 25/089

(57) ABSTRACT

An absorber assembly for an engine system and a method for operating the same is provided. The absorber assembly also includes a first section and a second section formed between the outer wall and the inner wall respectively. The absorber assembly further includes a pair of separator members extending within the main body unit. An inlet channel houses a first filter element therein. An outlet channel houses a second filter element therein. The absorber assembly further includes an internal flow path at a bottom portion of the main body unit. A triggering module is associated with the absorber assembly and is configured to trigger a regeneration thereof.

### TECHNICAL FIELD

The present disclosure relates to an air filtration system, and more particularly to the air filtration system having an absorber assembly for crankcase emission treatment in an engine system.

### BACKGROUND

During an operation of an engine, gases escape through piston rings of the engine. These blow-by gases include oil mist and other crankcase emissions. The crankcase emissions may include soluble hydrocarbons, wear particles and Unburned Hydrocarbon (UHC) emissions, and the like. With stringent emission regulations, it is important to control the crankcase emissions present in the blow-by gases. One method of controlling the crankcase emissions is a closed crankcase ventilation system wherein the blow-by gases are routed back into an intake system of the engine after filtration thereof.

A second method of controlling the crankcase emissions in the blow-by gases is to use an open crankcase ventilation system. In the open crankcase ventilation system, the blow-by gases are treated and then let out into the atmosphere. In order to treat the blow-by gases prior to discharge into the atmosphere, an air filtration system is generally associated with the engine for treatment of the blow-by gases exiting the engine. The air filtration unit may include a separator that separates oil mist from the blow-by gases. Further, the air filtration unit also includes a Hydrocarbon (HC) trap assembly. The HC trap assembly is configured to trap and oxidize the UHC present in the blow-by gases.

Over a period of use, an accumulation of the UHC on the absorber assembly of the air filtration unit may decrease an efficiency of the absorber assembly to absorb the UHC present in the blow-by gases. Therefore, the absorber assembly may have to be periodically regenerated to remove the trapped UHC therefrom.

One method of treating the blow-by gases is as discussed in U.S. Pat. No. 8,434,434, hereinafter referred as the '434 patent. The '434 patent describes a blow-by treatment assembly for a vehicle having an engine emitting blow-by gas including a duct for receiving blow-by gas from the engine. A catalyst trap is disposed in fluid communication with the duct. The catalyst trap removes hydrocarbon emissions from the blow-by gas. A pump pumps the blow-by gas through the catalyst trap. An outlet is in fluid communication with the catalyst trap for emitting the blow-by gas to either the ambient or to a tailpipe.

The '434 patent includes a dedicated blow-by treatment assembly for filtering of the blow-by gases before being let out into the atmosphere that is different from a treatment system for engine emissions. Further, the '434 patent also describes a separate regeneration system for regeneration of the UHC trapped in the blow-by treatment assembly that is distinct from that of the engine emission treatment system.

However, the system as described in '434 patent has additional costs associated therewith due to additional components required for the separate treatment of the blow-by gases and the exhaust gases respectively, as well as the regeneration of the components thereof. These additional components may also be bulky and occupy additional space in the engine system.

Another method of treating the blow-by gases is to force the blow-by gases into the exhaust gases so that both the engine and crankcase emissions are treated by an aftertreatment system of the engine system. However, such systems require extra power to force the crankcase emissions into the engine exhaust and further extra measures or devices may be needed to ensure that the engine exhaust gases do not flow into the crankcase.

### SUMMARY OF THE DISCLOSURE

In one aspect of the present disclosure, an absorber assembly for an engine system is provided. The absorber assembly includes a main body unit having a generally cylindrical configuration. The main body unit includes an outer wall and an inner wall, the inner wall defines a central cavity within the main body unit. The absorber assembly also includes a first section and a second section formed between the outer wall and the inner wall respectively. The absorber assembly further includes a pair of separator members extending within the main body unit. The pair of separator members is configured to separate the first and second sections from each other. The absorber assembly includes an inlet channel defined by the first section. The inlet channel is configured to house a first filter element therein. The absorber assembly also includes an outlet channel defined by the second section. The outlet channel is configured to house a second filter element therein. The absorber assembly further includes an internal flow path at a bottom portion of the main body unit, the internal flow path is provided between the first section and the second section. The internal flow path is configured to provide fluid communication between the first section and the second section.

In another aspect of the present disclosure, an engine system is provided. The engine system includes an aftertreatment system for exhaust gases. The aftertreatment system includes a diesel particulate filter unit operatively coupled to an engine. The aftertreatment system also includes an injector disposed on the diesel particulate filter unit. The engine system also includes an air filtration system for blow-by gases associated with a crankcase. The air filtration system includes an absorber assembly positioned within the diesel particulate filter unit. The absorber assembly also includes a main body unit having a generally cylindrical configuration. The main body unit further includes an outer wall and an inner wall. The inner wall defines a central cavity in the main body unit, wherein the central cavity receives the injector therein. The absorber assembly includes a first section and a second section formed between the outer wall and the inner wall respectively. The absorber assembly also includes a pair of separator members extending within the main body unit. The pair of separator members is configured to separate the first and second sections from each other. The absorber assembly further includes an inlet channel defined by the first section. The inlet channel houses a first filter element therein. The inlet channel is configured to receive an airflow from the engine. The absorber assembly includes an outlet channel defined by the second section; the outlet channel houses a second filter element therein. The outlet channel is configured to discharge a filtered airflow therefrom. The absorber assembly also includes an internal flow path provided at a bottom portion of the main body unit. The internal flow path is provided between the first section and the second section, the internal flow path is configured to provide fluid communication between the first section and the second section.

In yet another aspect of the present disclosure, a method for controlling a regeneration of a diesel particulate filter unit is provided. The method includes receiving a signal indicative of an operating parameter of at least one of an engine, the diesel particulate filter unit, an absorber assembly, or a combination thereof. The method also includes comparing the signal with a respective threshold. The method further includes triggering any one of a partial regeneration event, a full regeneration event, or a deactivation of regeneration event based on the comparison.

Other features and aspects of this disclosure will be apparent from the following description and the accompanying drawings.

### BRIEF DESCRIPTION OF THE DRAWINGS

FIG. 1 is a schematic view of an exemplary engine system, according to one embodiment of the present disclosure;

FIG. 2 is a perspective view of a diesel particulate filter unit and an absorber assembly, according to one embodiment of the present disclosure;

FIG. 3 is a top view of the absorber assembly of FIG. 2;

FIG. 4 is a perspective view of the absorber assembly of FIG. 2; and

FIG. 5 is a block diagram of an air filtration system, according to one embodiment of the present disclosure; and

FIGS. 6 and 7 are flowcharts of a method for controlling a regeneration of the diesel particulate filter unit.

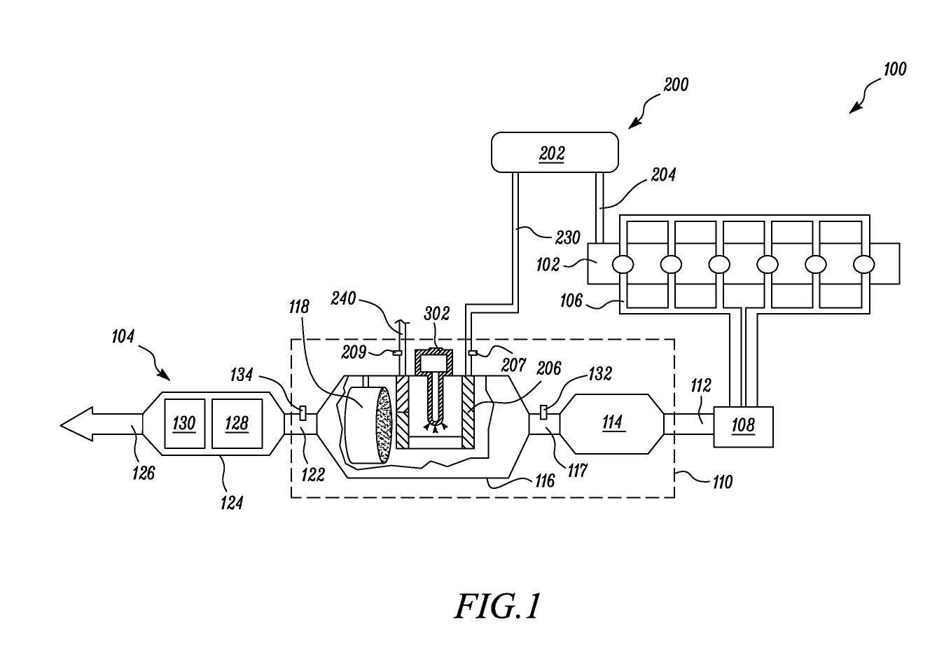

### DETAILED DESCRIPTION

Wherever possible, the same reference numbers will be used throughout the drawings to refer to the same or the like parts. Referring to FIG. 1, a schematic view of an exemplary engine system 100 is illustrated, according to one embodiment of the present disclosure. The engine system 100 includes an engine 102, which may be an internal combustion engine, such as, a reciprocating piston engine or a gas turbine engine. Alternatively, the engine 102 may be spark ignition engine or a compression ignition engine, such as, a diesel engine, a homogeneous charge compression ignition engine, or a reactivity controlled compression ignition engine, or other compression ignition engines known in the art. The engine 102 may be fueled by gasoline, diesel fuel, biodiesel, dimethyl ether, alcohol, natural gas, propane, hydrogen, combinations thereof, or any other combustion fuel known in the art.

The engine 102 may include other components, such as, a fuel system, an intake system, a drivetrain including a transmission system, and so on. The engine 102 may be used to provide power to any machine including, but not limited to, an on-highway truck, an off-highway truck, an earth moving machine, an electric generator, and so on. Further, the engine system 100 may be associated with an industry including, but not limited to, transportation, construction, agriculture, forestry, power generation, and material handling.

The engine system 100 includes an exhaust aftertreatment system 104 fluidly connected to an exhaust manifold 106 of the engine 102, via a turbocharger 108. The aftertreatment system 104 is configured to treat an exhaust gas flow exiting the exhaust manifold 106 of the engine 102. The exhaust gas flow may contain emission compounds including Nitrogen Oxides (NOx), unburned hydrocarbons, particulate matter and/or other combustion products known in the art. The aftertreatment system 104 is configured to trap or convert NOx, unburned hydrocarbons, particulate matter, combinations thereof, or other combustion products in the exhaust gas flow before exiting the engine system 100.

In the illustrated embodiment, the aftertreatment system 104 includes a first module 110. During engine operation, the first module 110 is arranged to internally receive engine exhaust gas, via the turbocharger 108. The first module 110 contains exhaust gas treatment devices, such as, a Diesel Oxidation Catalyst (DOC) unit 114 and a Diesel Particulate Filter (DPF) unit 116. The DOC unit 114 is fluidly coupled to the turbocharger 108 through a conduit 112. Further, the DOC unit 114 is fluidly coupled to the DPF unit 116 through a conduit 117.

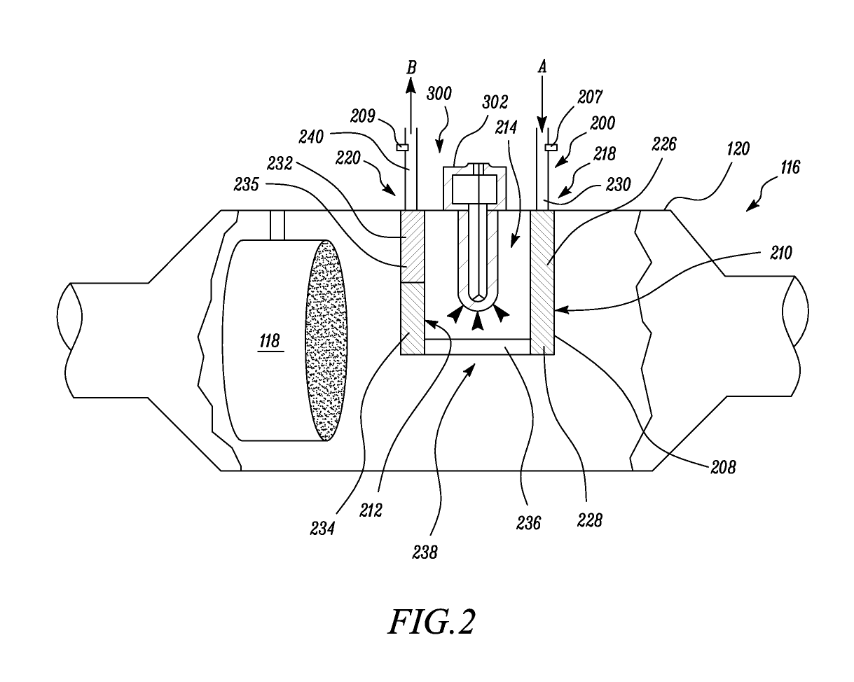

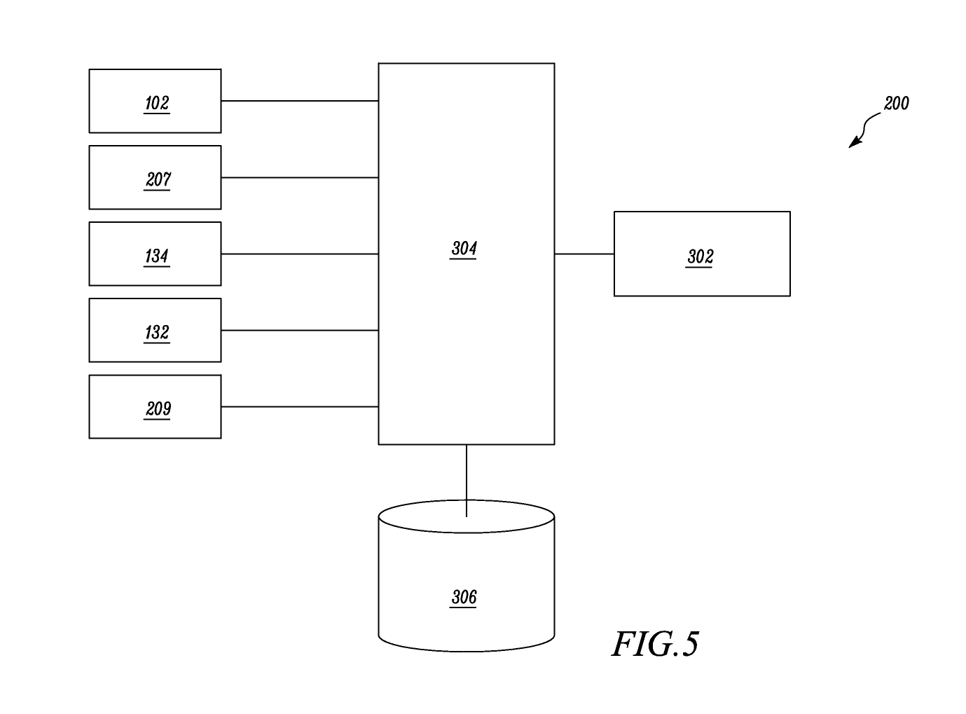

Referring to FIG. 2, a cut away view of the DPF unit 116 is shown. The DPF unit 116 may include a filtration media 118 provided within a housing 120 of the DPF unit 116. The filtration media 118 may include a wire mesh or ceramic honeycomb filtration media. The particulate matter present in the exhaust gas is filtered out or removed therefrom when the exhaust gas flow contacts with and flows through the filtration media 118. In order to measure the pressure drop across the DPF unit 116, a pair of pressure sensors 132, 134 is mounted at an inlet and an outlet of the DPF unit 116. The pair of sensors 132, 134 may send signals to a triggering module 304 (see FIG. 5) or an Electronic Control Module (ECM) (not shown) present on-board the machine in order to determine pressure drop across the DPF unit 116. The sensors 132, 134 may include any typical pressure sensor used for measuring pressure, such as, pressure transducer, piezometer, manometer, and the like.

Referring to FIG. 1, the exhaust gas flows into the first module 110 from the engine 102, passing through the DOC unit 114 and further down through the DPF unit 116 before entering a transfer conduit 122. The transfer conduit 122 is configured to fluidly interconnect the first module 110 with a second module 124, such that, the exhaust gas flow from the engine 102 may pass through the first and second modules 110, 124 in series, before being released at a stack 126 connected downstream of the second module 124. The second module 124 encloses a Selective Catalytic Reduction (SCR) module 128 and an Ammonia Oxidation Catalyst (AMOX) 130. The SCR module 128 operates to treat exhaust gases exiting the engine 102 in the presence of ammonia, which is provided after degradation of a urea-containing solution injected into the exhaust gases in the transfer conduit 122. The AMOX 130 is used to convert any ammonia slip from the downstream flow of the SCR module 128 before exiting the exhaust gas through the stack 126.

Referring now to FIGS. 1 and 2, the engine system 100 includes an air filtration system 200 to treat crankcase emissions present in the blow-by gases. It should be noted that the blow-by gases move through a different route from a route of the exhaust gases, and do not contact the exhaust gases at any point while flowing through the engine system 100. The crankcase emissions result from gases, known as blow-by gases, escaping past piston rings (now shown) of the engine 102. More particularly, as the blow-by gas passes through the crankcase (now shown), the blow-by gases may be entrained with oil mist. In addition to the oil moist, the crankcase emissions include particulate matter, such as, soluble hydrocarbons, wear particles, and Unburned Hydrocarbon (UHC) emissions. The air filtration system 200 is configured to control and eliminate all crankcase emissions including UHC from the blow-by gases. The air filtration system 200 illustrated herein is embodied as an open crankcase ventilation system. However, in another embodiment, the air filtration system 200 may also be embodied as a closed crankcase ventilation system, wherein the blow-by gases are treated and re-introduced into the engine 102.

The air filtration system 200 includes a filtration unit 202. The filtration unit 202 is fluidly coupled to the crankcase, through a conduit 204. The filtration unit 202 is configured to filter or separate oil mist and any other particulate matter entrained in the blow-by gases. In order to filter the UHC emissions, from the blow-by gases, the air filtration system 200 includes an absorber assembly 206. As shown in FIGS. 1 and 2, the absorber assembly 206 is operatively coupled with a regeneration system 300. The absorber assembly 206 will now be explained in detail with reference to FIGS. 1-4.

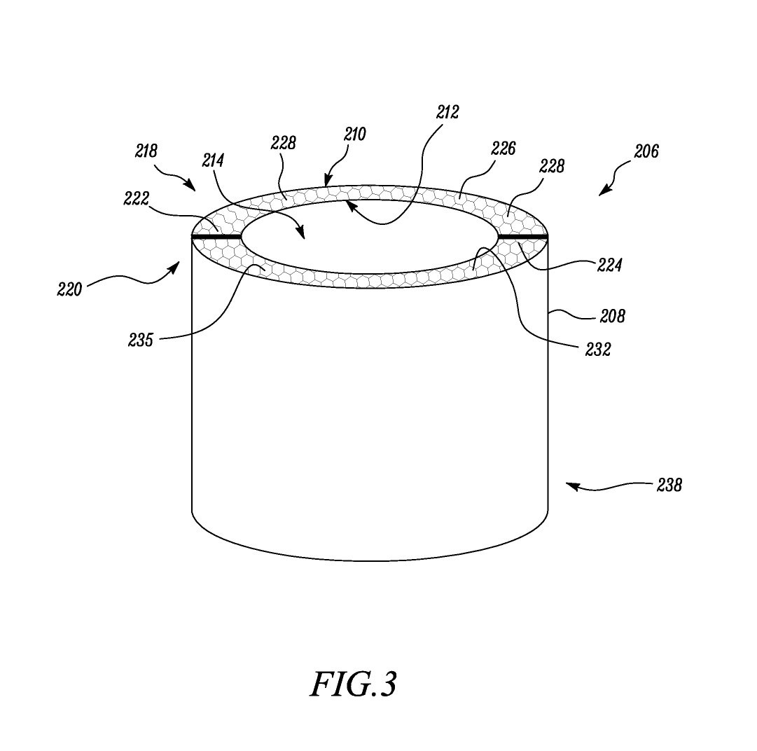

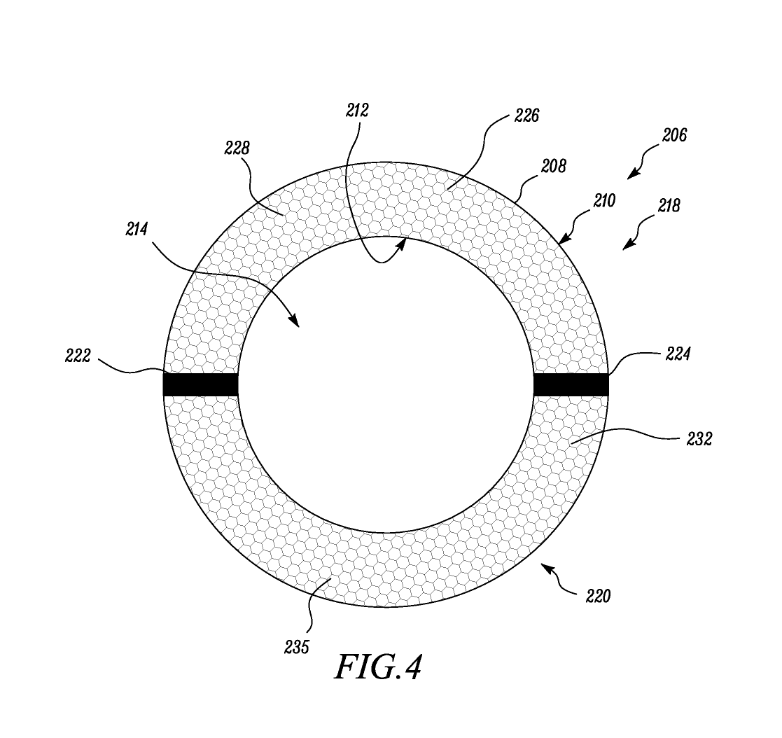

FIG. 3 is a perspective view of the absorber assembly 206. The absorber assembly 206 includes a main body unit 208. The main body unit 208 has a generally cylindrical configuration. The main body unit 208 may be manufactured of a material that is highly resistant to high temperatures and/or pressures. The main body unit 208 may be made of a metal or a non-metal. In one example, the main body unit 208 may be made of steel. Alternatively, the main body unit 208 may be made of a different metal or its alloy, or a polymer. The main body unit 208 includes an outer wall 210 and an inner wall 212. The outer and inner walls 210, 212 are concentric with each other. Referring to FIGS. 3 and 4, the inner wall 212 defines a central cavity 214 within the main body unit 208. The central cavity 214 of the main body unit 208 is configured to receive an injector 302 therein. Further, the central cavity 214 provides a confined space that acts as combustion chamber or enclosure during a regeneration event of the DPF unit 116 and/or the absorber assembly 206, which will be explained later in this section

The absorber assembly 206 has a first section 218 and a second section 220. The first and second sections 218, 220 are formed between the outer and inner walls 210, 212 of the main body unit 208 respectively. The absorber assembly 206 includes a pair of separator members 222, 224. The pair of separator members 222, 224 extends within the main body unit 208 along a height of the main body unit 208. The pair of separator members 222, 224 is disposed at diametrically opposite locations within the main body unit 208. The pair of separator members 222, 224 is configured to separate the first and second sections 218, 220 from each other. The separator members 222, 224 act as an insulator between the first and second sections 218, 220. The pair of separator members 222, 224 may be made from a metal or a non-metal. In one example, the pair of separator members 222, 224 may be made of steel.

The absorber assembly 206 includes an inlet channel 226. The inlet channel 226 is defined by the first section 218 of the main body unit 208. The inlet channel 226 is configured to house a first filter element 228 therein. The inlet channel 226 is operatively coupled to the engine 102. More particularly, the inlet channel 226 is provided in fluid communication with the filtration unit 202, through a conduit 230 (see FIG. 1). The inlet channel 226 of the absorber assembly 206 is configured to receive the blow-by gases leaving the filtration unit 202.

The absorber assembly 206 includes an outlet channel 232. The outlet channel 232 is defined by the second section 220 of the main body unit 208. The outlet channel 232 is configured to house a second filter element 234 therein. Further, the outlet channel 232 is configured to open to atmosphere through a conduit 240. The blow-by gases filtered by the absorber assembly 206 exits the engine system 100 through the outlet channel 232.

The first and second filter elements 228, 234 may include any filtration membrane or material that may effectively trap the UHC emissions present in the blow-by gases, when the blow-by gases pass therethrough. In one example, at least one of the first and second filter elements 228, 234 includes zeolite or other known material coated onto a monolithic cordierite carrier. It should be noted that the material used for the first and second filter elements 228, 234 may be different from each other, based on system requirements. Further, a part of the second filter element 234 may include an oxidation catalyst 235 (see FIG. 2).

Referring now to FIGS. 2 and 3, the absorber assembly 206 includes an internal flow path 236. The internal flow path 236 is provided at a bottom portion 238 of the main body unit 208. More particularly, the internal flow path 236 is provided between the first section 218 and the second section 220, and is configured to provide fluid communication between the first section 218 and the second section 220 of the absorber assembly 206.

The absorber assembly 206 includes a pair of sensors 207, 209 positioned respectively at an entry and exit thereof. The sensors 207, 209 are configured to detect an amount of the UHC present in the blow-by gases at the entry and exit of the absorber assembly 206. In one example, the sensors 207, 209 may include any hydrocarbon sensors known in the art. The absorber assembly 206 may also include pressure sensors (not shown) positioned at the entry and exit of the absorber assembly 206, which may be used for analyzing pressure drop across the absorber assembly 206.

The blow-by gases exit from the crankcase of the engine 102 through the conduit 204. The blow-by gases flow through the filtration unit 202, wherein the oil mist and other particulate matter are removed or separated therefrom. The blow-by gases then flow towards the absorber assembly 206 through the conduit 230. More particularly, the blow-by gases enter the inlet channel 226 of the absorber assembly 206 as shown by arrow “A” (see FIG. 2); and contact the first filter element 228 present therein. Further, the blow-by gases flow through the internal flow path 236 and are introduced into the outlet channel 232 of the absorber assembly 206. The blow-by gases enter the outlet channel 232 of the absorber assembly 206 and contact the second filter element 234 present therein. On flowing through the first filter element, second filter element, and oxidation catalyst 228, 234, 235 present within the inlet and outlet channel 226, 232 respectively, the UHC emissions present in the blow-by gases may be trapped by the first and second filter elements 228, 234, and the trapped UHC can be converted to CO2 and H20 over the oxidation catalyst 235 during the regeneration event. Further, the blow-by gases that are substantially free from any particulate matter and the UHC are let out in the atmosphere from the outlet channel 232, as shown by arrow “B” (see FIG. 2);.

Referring now to FIGS. 1 and 2, the particulate matter present in the exhaust gas flow may stick to and buildup on the filtration media 118 of the DPF unit 116 over a period of time, and if left unchecked, the particulate matter buildup could be significant enough to restrict or in some cases block the flow of the exhaust gases therethrough. A restriction in the outflow of exhaust gases may increase a back pressure in the engine 102. The backpressure in the engine 102 may reduce the engine's ability to draw in fresh air, resulting in decreased performance, increased exhaust temperatures, and poor fuel consumption. The filtration media 118 of the DPF unit 116 may therefore require periodic regeneration in order to eliminate particulate matter from the filtration media 118. Hence, the aftertreatment system 104 includes the regeneration system 300. The regeneration system 300 is configured to reduce a buildup of particulate matter within the filtration media 118 of the DPF unit 116.

In one embodiment, the regeneration system 300 may be placed within the housing 120 of the DPF unit 116. For example, the regeneration system 300 can be positioned within the housing 120 of the DPF unit 116 before the filtration media 118. Alternatively, the regeneration system 300 can be placed in the conduit 117 that provides fluid communication between the DOC unit 114 and the DPF unit 116. It should be noted that the diagrammatic representation of the regeneration system 300 and the absorber assembly 206 is for exemplary and illustrative purposes, and dimensionally may not be accurate in real world environments. The representations have been enlarged or scaled up for clarity purposes.

It should be further noted that the first and second filter element 228, 234 of the absorber assembly 206 may become saturated when more and more UHC is trapped by the absorber assembly 206. The saturation may result in inefficient or decreased absorption of the UHC by the absorber assembly 206. The absorber assembly 206 may therefore require periodic regeneration in order to oxidize the UHC trapped therein. In one embodiment of the present disclosure, the absorber assembly 206 is regenerated by the regeneration system 300 of the DPF unit 116. In some examples, the filtration media 118 and the absorber assembly 206 may be regenerated simultaneously.

Referring to FIGS. 1, 2, and 5, the regeneration system 300 includes the injector 302. The injector 302 may be disposed within the housing 120 of the DPF unit 116, and more particularly within the central cavity 214 of the absorber assembly 206. The injector 302 may be operable to inject an amount of pressurized fuel into the DPF unit 116 at predetermined timings, fuel pressures, and fuel flow rates. The timing and amount of fuel injection into the DPF unit 116 may be based on the buildup of the particulate matter within the DPF unit 116 and the UHC within the absorber assembly 206. The regeneration system 300 may also include the triggering module 304 (see FIG. 5). It is contemplated that the regeneration system 300 may include additional or different components (not shown) such as, for example, a spark plug, a pure system, one or more pilot injectors, additional main injectors, a pressure sensor, a temperature sensor, a flow sensor, a flow blocking device, and other components known in the art.

It will be apparent to those skilled in the art that various modifications and variations can be made to the regeneration system 300 disclosed herein without departing from the scope of the disclosure. Further, the regeneration system 300 may include any type of known regeneration system capable of regenerating the DPF unit 116 and the absorber assembly 206. Other embodiments will be apparent to those skilled in the art from consideration of the specification and practice of the regeneration system 300 disclosed herein. For example, the injector 302 may draw pressurized fuel from a common rail fuel system associated with the engine 102; the injector 302 may alternatively draw pressurized fuel from a separate dedicated source, if desired. It is intended that the specification and examples be considered as exemplary only, with a true scope of the disclosure being indicated by the following claims and their equivalents.

The triggering module 304 may be communicably coupled to the engine 102, the DPF unit 116, the absorber assembly 206, and is capable of receiving signals therefrom. The triggering module 304 is configured to control the regeneration of the DPF unit 116 and the absorber assembly 206. It should be noted that the functions of the triggering module 304 may be performed by known standard modules for regeneration control known to a person of ordinary skill in the art. In one example, the function of regeneration control performed by the triggering module 304 may be stored in the ECM of the machine. The triggering module 304 may be configured to receive a signal indicative of an operating parameter of the engine 102, the DPF unit 116, the absorber assembly 206, or a combination thereof. In one example, the operating parameter of the engine 102 includes running hours of the engine 102, and more particularly the running hours of the engine 102 from a previous or prior regeneration event of the DPF unit 116 or the absorber assembly 206. In another embodiment, the operating parameter of the engine 102 may include a back pressure of the engine 102. The back pressure may be indicative of a restriction experienced by the engine 102 to the exhaust gas flow therefrom. This may increase the back pressure of the engine 102 and reduce an ability of the engine 102 to draw in fresh air, resulting in decreased performance of the engine 102.

The operating parameter of the DPF unit 116 may include a back pressure. The back pressure may be indicative of an amount of back pressure within the DPF unit 116 that reduces an ability of the DPF unit 116 to draw in and separate the particulate matter from the exhaust gas flow entering therein. The back pressure across the DPF unit 116 may be measured by the sensor 132. Alternatively, the operating parameter of the DPF unit 116 may include a soot loading model. The soot loading model may be configured to estimate soot loading on the filtration media 118. In one example, the database 306 may store a calibrated soot loading model for the DPF unit 116. The calibrated soot loading model is a regression model that may be developed for the DPF unit 116 during an engine calibration process.

During engine operation, the soot loading model of the DPF unit 116 may change based on the soot loading on the filtration media 118. Accordingly, the soot loading model may be estimated at different times during the engine operation. In one example, the soot loading model may estimate soot loading as a function of a pressure drop across the DPF unit 116 at a given volume flow rate. Over a period of time, the DPF unit 116 may be monitored to obtain at least one pressure drop measurement at a particular volume flow rate, and the soot loading model of the DPF unit 116 can be estimated as a function of the at least one pressure drop measurement at the particular volume flow rate. The pressure drop across the DPF unit 116 may be determined using the sensor 132, 134.

The triggering module 304 may receive the signal indicative of the operating parameter of the absorber assembly 206. In one example, the operating parameter includes storage capacity of the absorber assembly 206. The term “storage capacity” referred to herein may be indicative of an amount of the UHC that can be trapped and held by the first and second filter elements 228, 234. In another example, the triggering module 304 may also receive the back pressure and soot loading model of the absorber assembly 206.

The triggering module 304 may receive the signal indicative of the running hours of the engine 102, soot loading model and back pressure of the DPF unit 116, storage capacity of the absorber assembly 206, or a combination thereof. These signals may be received from different sensors associated with the engine system 100 or from the ECM present on-board the machine. In one example, a database 306 may store predetermined thresholds corresponding to the required running hours of the engine 102 from the previous regeneration event. More particularly, the predetermined threshold referred to herein corresponds to the maximum number of hours that the DPF unit 116 may work between two consecutive regeneration events. The database 306 may further store other predetermined thresholds for the soot loading model and the back pressure of the DPF unit 116. The predetermined thresholds may be indicative of or correspond to the soot loading model and the back pressure favorable for a normal operation of the DPF unit 116. Further, the database 306 may also store yet other predetermined thresholds corresponding to the storage capacity of the absorber assembly 206. The predetermined threshold may correspond to the maximum allowable UHC that may be trapped by the absorber assembly 206.

The triggering module 304 is communicably coupled to the injector 302 and the database 306. Based on the received operating parameter signals, the triggering module 304 is configured to retrieve the information of the respective predetermined thresholds of the running hours of the engine 102, the calibrated soot loading model, the back pressure, the storage capacity, or a combination thereof from the database 306. The triggering module 304 may compare the signals indicative of the operating parameters associated with the engine 102, the DPF unit 116, the absorber assembly 206, or a combination thereof, with the respective predetermined threshold received from the database 306.

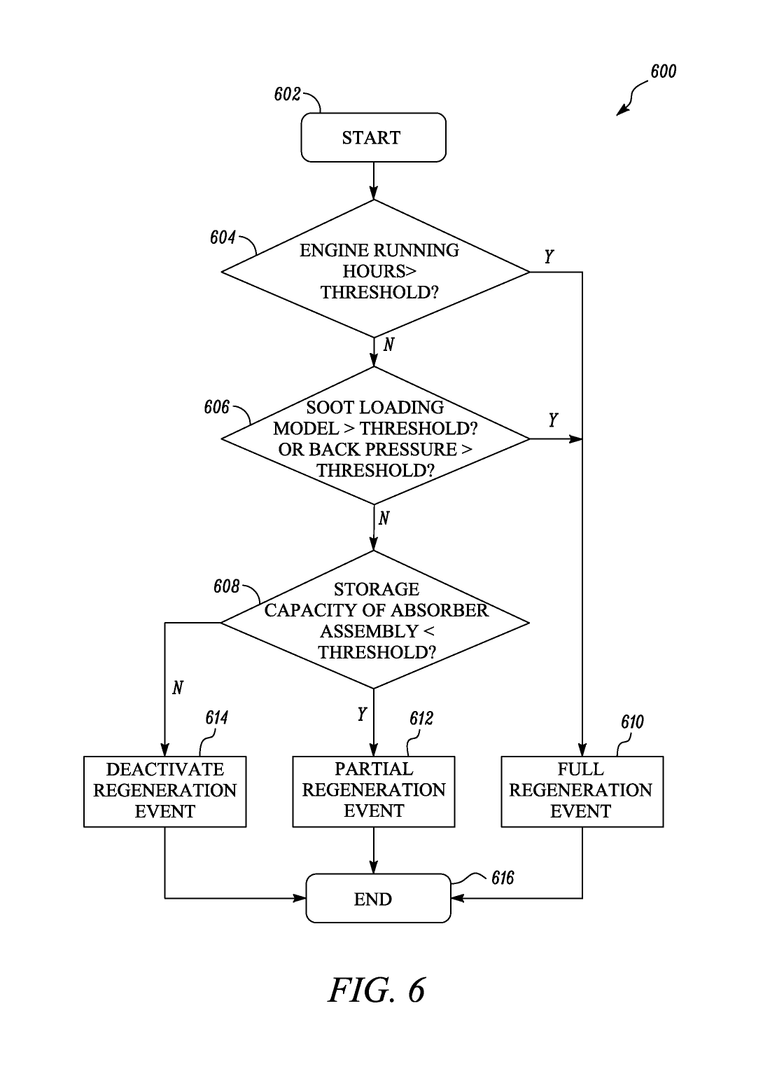

A working of the triggering module 304 will now be explained in detail with reference to FIG. 6. FIG. 6 is a process 600 that may be stored in the triggering module 304 in order to identify a mode of operation of the regeneration system 300. Alternatively, the process 600 may also be stored in the ECM present on-board the machine, and may be retrieved by the triggering module 304 therefrom. The process 600 (or algorithm) begins at step 602 in which the method implemented by the triggering module 304 or the ECM starts or begins operation. The regeneration system 300 may operate in three modes, i.e., a full regeneration event, a partial regeneration event, or a deactivation of the regeneration event. It should be noted that the activation of the regeneration system 300 may be manual, and an operator of the machine may activate the regeneration system 300 based on operational requirements. Alternatively, the triggering module 304 may automatically activate the regeneration system 300, based on signals received from the ECM or the various sensors present on-board the machine.

At step 604, the process 600 is configured to decide the mode of operation of the regeneration system 300. The triggering module 304 may compare the engine running hours since the latest regeneration event of the DPF unit 116 with the respective threshold retrieved from the database 306. Further, the triggering module 304 may also compare the engine running hours since the latest regeneration event of the absorber assembly 206 with the respective threshold retrieved from the database 306. In a situation wherein, either one of the engine running hours since the latest regeneration event of the DPF unit 116 or the absorber assembly 206 is greater than the respective predetermined threshold, the triggering module 304 may move on to step 610 and trigger the full regeneration event, and the process 600 ends at step 616.

In the full regeneration event, the injector 302 may be configured to initiate a pilot fuel injection of fuel as well as main fuel injection of the fuel. More particularly, the spark plug may facilitate ignition of fuel sprayed from the injector 302 into the central cavity 214 of the absorber assembly 206. It should be noted that the injection is enclosed within the central cavity 214 for proper injection and ignition of the fuel, which may otherwise be difficult to perform in the DPF unit 116 due to presence of exhaust gases therewithin.

Further, to initiate combustion of the fuel and subsequently the trapped particulate matter in the DPF unit 116 and the UHC trapped in the absorber assembly 206, a small quantity or a pilot shot of fuel injection from the injector 302 may be sprayed or otherwise injected toward the spark plug. The pilot fuel injection creates a locally rich atmosphere readily ignitable by the spark plug. A spark developed across electrodes of the spark plug may ignite the locally rich atmosphere creating a flame within the central cavity 214, which can ignite available fuels injected during the main fuel injection.

It should be noted that heat generated after the pilot fuel injection is lower compared to heat generated after the main fuel injection. However the heat is sufficient enough the regenerate the absorber assembly 206 as the UHC trapped in the absorber assembly 206 is partially burned fuel and therefore needs a lower temperature to oxidize as compared to the regeneration of the particulate matter accumulated on the filtration media 118. Hence, the heat generated during the pilot fuel injection is only sufficient to regenerate the absorber assembly 206 and not the filtration media 118 of the DPF unit 116.

During the regeneration event of the absorber assembly 206, a temperature of the first filter element 228, the second filter element 234, and the oxidation catalyst 235 of the absorber assembly 206 may increase due to heat exchange of the first filter element 228, the second filter element 234, and the oxidation catalyst 235 with the central cavity 214 of the absorber assembly 206 where the combustion takes place. Due to the temperature increase, the UHC absorbed by the first and second filter elements 228, 234 are released and flow towards the outlet channel 232 of the absorber assembly 206. While flowing towards the outlet channel 232, the UHC contacts the oxidation catalyst 235. The trapped UHC is converted to CO2 and H2O over the heated oxidation catalyst 235 of the absorber assembly 206.

Further, the flame jet propagating from the injector 302 may also raise the temperature within the DPF unit 116 to a level, which readily supports ignition of a larger quantity or the main shot of fuel injection from the injector 302. As the main injection of fuel ignites, the temperature within the DPF unit 116 may continue to rise to a level that causes ignition of the particulate matter trapped within the filtration media 118, thereby causing the regeneration thereof.

In a situation wherein the engine running hours without the regeneration event of the DPF unit 116 or the absorber assembly 206 is lesser than the predetermined threshold, the process 600 moves on to the next step 606 of the process 600. At step 606, the triggering module 304 retrieves the calibrated soot loading model and predetermined threshold corresponding to the back pressure in the DPF unit 116. More particularly, the database 306 stores the calibrated soot loading model for the DPF unit 116 therein.

The triggering module 304 may compare the estimated soot level derived from the calibrated soot loading model with the predetermined threshold. If the estimated soot level is higher than the respective predetermined threshold, the triggering module 304 may move to step 610 and trigger the full regeneration event. Also, the triggering module 304 may compare the back pressure with the respective threshold. If the back pressure is higher than the respective predetermined threshold, the triggering module 304 may trigger the full regeneration event. It should be noted that the triggering module 304 may compare any one or both of the estimated soot level and the back pressure of the DPF unit 116 with the respective predetermined thresholds retrieved from the database 306, and trigger the full regeneration event accordingly.

In one embodiment of the present disclosure, when the results of the estimated soot level and the back pressure are both lesser than the predetermined threshold, the process 600 moves on to the next step 608. At step 608, the triggering module 304 may compare the storage capacity of the absorber assembly 206 with the predetermined threshold. If the storage capacity is lesser than the predetermined threshold, the triggering module 304 may be configured to move to step 612 of the process 600 and trigger the partial regeneration event, and the process 600 ends at step 616. In the partial regeneration event, the injector 302 may initiate a pilot fuel injection, as described at step 604, within the DPF unit 116 that is sufficient enough to regenerate the absorber assembly 206. It should be specifically noted that during the partial regeneration event, the heat produced within the central cavity 214 of the absorber assembly 206 is not sufficient to regenerate the DPF unit 116.

Further, in a situation wherein the storage capacity of the absorber assembly 206 is greater than the respective predetermined threshold, the process 600 may move on to step 614, where the regeneration mode is deactivated, and the process 600 ends at step 616.

The location of the database 306 may vary based on the application. The predetermined thresholds stored within the database 306 may be retrieved from any external source(s) and/or updated on a real time basis. The database 306 may be any conventional or non-conventional database known in the art. Moreover, the database 306 may be capable of storing and/or modifying pre-stored data as per operational and design needs.

The triggering module 304 may embody a single microprocessor or multiple microprocessors for receiving signals from components of the engine system 100. Numerous commercially available microprocessors may be configured to perform the functions of the triggering module 304. It should be appreciated that the triggering module 304 may embody a machine microprocessor capable of controlling numerous machine functions. A person of ordinary skill in the art will appreciate that the triggering module 304 may additionally include other components and may also perform other functions not described herein.

### INDUSTRIAL APPLICABILITY

The present disclosure describes the air filtration system 200 for treating blow-by gases associated with the crankcase. The air filtration system 200 includes the absorber assembly 206. The absorber assembly 206 is configured to reduce and/or eliminate the UHC present in the blow-by gases. The absorber assembly 206 includes the first filter element 228, the second filter element 234, and the oxidation catalyst 235 that are configured to respectively trap and oxidize the UHC present in the blow-by gases. The absorber assembly 206 described herein has a compact design, such that the absorber assembly 206 is provided within the housing 120 of the DPF unit 116. Further, the injector 302 of the regeneration system 300 is configured to be enclosed within the central cavity 214 of the main body unit 208. During the regeneration event of the DPF unit 116 and/or the absorber assembly 206, the central cavity 214 provides the confined combustion chamber for the fuel for proper ignition and heat production thereby.

The regeneration system 300 may be used to regenerate the DPF unit 116 and the absorber assembly 206. In some examples, both the DPF unit 116 and the absorber assembly 206 may be regenerated at the same time, based on system requirements. Accordingly, the engine system 100 may not require a separate regeneration system for regenerating the absorber assembly 206, thereby reducing cost associated with the separate regeneration unit.

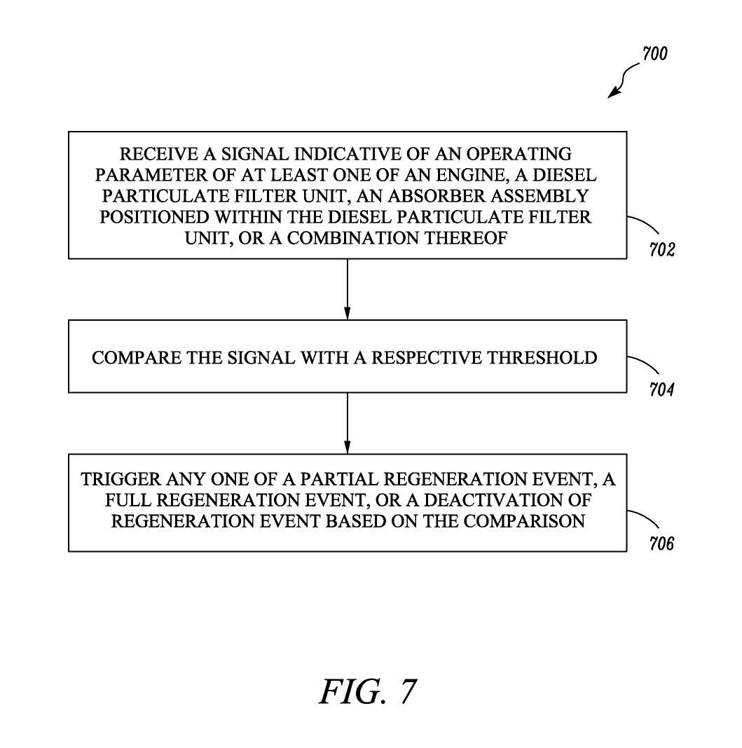

FIG. 7 is a flowchart for a method 700 of controlling regeneration of the DPF unit 116 and the absorber assembly 206. At step 702, the triggering module 304 is configured to receive the signal indicative of the operating parameter of at least one of the engine 102, the DPF unit 116, the absorber assembly 206, or a combination thereof. The operating parameter of the engine 102 includes running hours of the engine 102. More particularly, the operating parameter of the engine 102 includes running hours of the engine 102 from the previous regeneration event of the DPF unit 116 or the absorber assembly 206. Further, the operating parameter of the DPF unit 116 includes at least one of the soot loading model, the back pressure, or a combination thereof associated with the DPF unit 116. Whereas, the operating parameter of the absorber assembly 206 includes the storage capacity of the absorber assembly 206.

At step 704, the triggering module 304 is configured to compare the signal with the respective threshold of the engine 102, the DPF unit 116, and the absorber assembly 206. At step 706, the triggering module 304 is configured to trigger any one of the partial regeneration event, the full regeneration event, or the deactivation of regeneration event of at least one of the DPF unit 116 or the absorber assembly 206, based on the comparison. The full regeneration event is triggered when at least one of the operating parameter associated with the engine 102 or the DPF unit 116 exceeds the respective threshold. Further, the partial regeneration event is triggered when the operating parameter associated with the absorber assembly 206 exceeds the respective threshold.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An absorber assembly for an engine system, the absorber assembly comprising:
a main body unit having a generally cylindrical configuration, the main body unit including an outer wall and an inner wall, the inner wall defining a central cavity within the main body unit;
a first section and a second section formed between the outer wall and the inner wall respectively;
a pair of separator members extending within the main body unit, the pair of separator members configured to separate the first and second sections from each other;
an inlet channel defined by the first section, the inlet channel configured to house a first filter element therein;
an outlet channel defined by the second section, the outlet channel configured to house a second filter element therein; and
an internal flow path at a bottom portion of the main body unit, the internal flow path provided between the first section and the second section, the internal flow path configured to provide fluid communication between the first section and the second section.

2. The absorber assembly of claim 1, wherein the absorber assembly is provided within a diesel particulate filter unit.

3. The absorber assembly of claim 1, wherein the absorber assembly is provided within a conduit associated with a diesel particulate filter unit.

4. The absorber assembly of claim 1, wherein the inlet channel is operatively coupled to an engine.

5. The absorber assembly of claim 1, wherein the central cavity of the main body unit is configured to receive an injector therein.

6. The absorber assembly of claim 1, wherein at least one of the first or second filter elements include zeolite.

7. The absorber assembly of claim 1, wherein the outlet channel opens to atmosphere.

8. The absorber assembly of claim 1, wherein the pair of separator members are disposed at diametrically opposite locations within the main body unit.

9. An engine system comprising:
an aftertreatment system for exhaust gases, the aftertreatment system comprising:
a diesel particulate filter unit operatively coupled to an engine; and
an injector disposed on the diesel particulate filter unit; and
an air filtration system for blow-by gases associated with a crankcase, the air filtration system comprising:
an absorber assembly positioned within the diesel particulate filter unit, the absorber assembly comprising:
a main body unit having a generally cylindrical configuration, the main body unit including an outer wall and an inner wall, the inner wall defining a central cavity in the main body unit, wherein the central cavity receives the injector therein;
a first section and a second section formed between the outer wall and the inner wall respectively;
a pair of separator members extending within the main body unit, the pair of separator members configured to separate the first and second sections from each other;
an inlet channel defined by the first section, the inlet channel housing a first filter element therein, the inlet channel configured to receive an airflow from the engine;
an outlet channel defined by the second section, the outlet channel housing a second filter element therein, the outlet channel configured to discharge a filtered airflow therefrom; and
an internal flow path at a bottom portion of the main body unit, the internal flow path provided between the first section and the second section, the internal flow path configured to provide fluid communication between the first section and the second section.

10. The engine system of claim 9 further comprising a triggering module communicably coupled to the injector.

11. The engine system of claim 10, wherein the triggering module is configured to:
receive a signal indicative of an operating parameter of at least one of the engine, the diesel particulate filter unit, the absorber assembly, or a combination thereof;
compare the signal with a respective threshold; and
trigger any one of a partial regeneration event, a full regeneration event, or a deactivation of regeneration event based on the comparison.

12. The engine system of claim 11, wherein the operating parameter of the engine includes running hours of the engine.

13. The engine system of claim 11, wherein the operating parameter of the diesel particulate filter unit includes at least one of a soot loading model, a back pressure, or a combination thereof associated with the diesel particulate filter unit.

14. The engine system of claim 11, wherein the operating parameter of the absorber assembly includes a storage capacity thereof.

15. A method for controlling a regeneration of a diesel particulate filter unit, the method comprising:
receiving a signal indicative of an operating parameter of at least one of an engine, the diesel particulate filter unit, an absorber assembly, or a combination thereof;
comparing the signal with a respective threshold; and
triggering any one of a partial regeneration event, a full regeneration event, or a deactivation of regeneration event based on the comparison.

16. The method of claim 15, wherein the operating parameter of the engine includes running hours of the engine.

17. The method of claim 15, wherein the operating parameter of the diesel particulate filter unit includes at least one of a soot loading model, a back pressure, or a combination thereof associated with the diesel particulate filter unit.

18. The method of claim 15, wherein the operating parameter of the absorber assembly includes a storage capacity thereof.

19. The method of claim 15, wherein the full regeneration event is triggered when at least one of the operating parameter associated with the engine or the diesel particulate filter unit exceeds the respective threshold.

20. The method of claim 15, wherein the partial regeneration event is triggered when the operating parameter associated with the absorber assembly exceeds the respective threshold.
